(19) United States
(12) Patent Application Publication
(10) Pub. No.: US 2011/0068686 A1
(43) Pub. Date: Mar. 24, 2011

(54) LED LAMP

(75) Inventor: Hideharu Osawa, Kyoto (JP)

(73) Assignee: ROHM CO., LTD., Kyoto-shi, Kyoto (JP)

(21) Appl. No.: 12/993,221

(22) PCT Filed: Jun. 8, 2009
(86) PCT No.: PCT/JP2009/060454

§ 371 Date: Nov. 17, 2010

(30) Foreign Application Priority Data
Jun. 11, 2008 (JP) 2008-152431

(51) Int. Cl. H01J 7/44

(52) U.S. Cl. 315/32

(57) ABSTRACT

An LED lamp A1 includes a plurality of LED modules 20, and a controller 40 for switching the LED modules 20 between a light-emission state and a non-light-emission state. The controller 40 performs control to bring only part of the LED modules 20 into the light-emission state. This arrangement allows illumination in a particular direction with less electric power.

### TECHNICAL FIELD

The present invention relates to an LED lamp that uses a light emitting diode Thereinafter referred to as “LED”) as the light source and that can be used as a substitute for a fluorescent lamp, for example.

### BACKGROUND ART

Fluorescent lamps used for a general-purpose fluorescent lighting fixture have drawbacks such as a short life, inclusion of harmful substances such as mercury or lead and attraction of insects. In view of this, LED lamps, which use LEDs as the light source, have been developed. Herein, the general-purpose fluorescent lighting fixture refers to a lighting fixture widely used mainly for general indoor lighting, and more specifically to a lighting fixture that uses, for example in Japan, the commercial power supply of 100 V or 200 V, and is compatible with a straight-tube fluorescent lamp according to JIS C7617 or a circular fluorescent lamp according to JIS C7618.

FIG. 5 is a sectional view showing an example of conventional LED lamp (see Patent Document 1 for example). The LED lamp X shown in the figure includes an elongated rectangular substrate 91, a plurality of LEDs 92 mounted on the substrate 91, a tube 93 accommodating the substrate 91, and a terminal 94, and is used as a substitute for a straight-tube fluorescent lamp. A wiring pattern, not shown, is formed on the surface of the substrate 91 for connection to the terminal 94. The LEDs 92 are mounted on the wiring pattern. With this LED lamp X, fitting the terminal 94 into the inlet port of a socket of a general-purpose fluorescent lighting fixture allows the plurality of LEDs 92 to be turned on.

In recent years, lighting apparatuses that can illuminate only in a particular direction are demanded, in order to illuminate only a particular product shelf in a shop or illuminate only one side of a room with light. However, fluorescent lamps and the conventional LED lamp X emit light from the entirety. Thus, to illuminate only in a particular direction, part of the fluorescent lamp or the LED lamp X needs to be covered. With this arrangement, power consumption does not reduce, although only a little amount of the light emitted is used for illumination.

Patent Document 1: JP-U-6-54103

### DISCLOSURE OF THE INVENTION

### Problems to be Solved by the Invention

The present invention has been proposed under the circumstances described above. It is therefore an object of the present invention to provide an LED lamp that allows illumination in a particular direction with less electric power.

### Means for Solving the Problems

To solve the problems described above, the present invention takes the following technical measures.

An LED lamp provided according to the present invention includes a plurality of LEDs, and a controller for switching the LEDs between a light-emission state and a non-light-emission state. The controller performs control to bring only part of the LEDs into the light-emission state.

In a preferred embodiment of the present invention, the LEDs are arranged in a plurality of rows extending parallel to each other. The controller performs switching of the LEDs between the light-emission state and the non-light-emission state individually with respect to each of the rows.

In a preferred embodiment of the present invention, the LED lamp further includes at least one receiver which is connected to the controller and which receives a signal from outside. The controller performs control to switch the LEDs included in at least one of the rows between the light-emission state and the non-light-emission state in accordance with a signal received by the receiver.

In a preferred embodiment of the present invention, the same number of receivers as the number of rows is provided. The controller makes the plurality of rows associated with different receivers, respectively, and when one of the receivers receives a signal from outside, the controller performs control to switch the LEDs included in the row associated with the receiver between the light-emission state and the non-light-emission state.

In a preferred embodiment of the present invention, the LED lamp further includes at least one light-shielding wall extending parallel to the rows and arranged between adjacent ones of the rows.

In a preferred embodiment of the present invention, at least part of the light-shielding wall overlaps the LEDs in a direction perpendicular to both the direction in which the rows extend and a direction in which the rows are arranged side by side.

Other features and advantages of the present invention will become more apparent from the detailed description given below with reference to the accompanying drawings.

### BRIEF DESCRIPTION OF THE DRAWINGS

FIG. 1 is a plan view showing an example of LED lamp according to a first embodiment of the present invention;

FIG. 2 is a sectional view taken along lines II-II in FIG. 1;

FIG. 3 is a plan view showing an example of LED lamp according to a second embodiment of the present invention;

FIG. 4 is a sectional view taken along lines IV-IV in FIG. 3; and

FIG. 5 is a sectional view showing an example of conventional LED lamp.

### BEST MODE FOR CARRYING OUT THE INVENTION

Preferred embodiments of the present invention are described below with reference to the accompanying drawings.

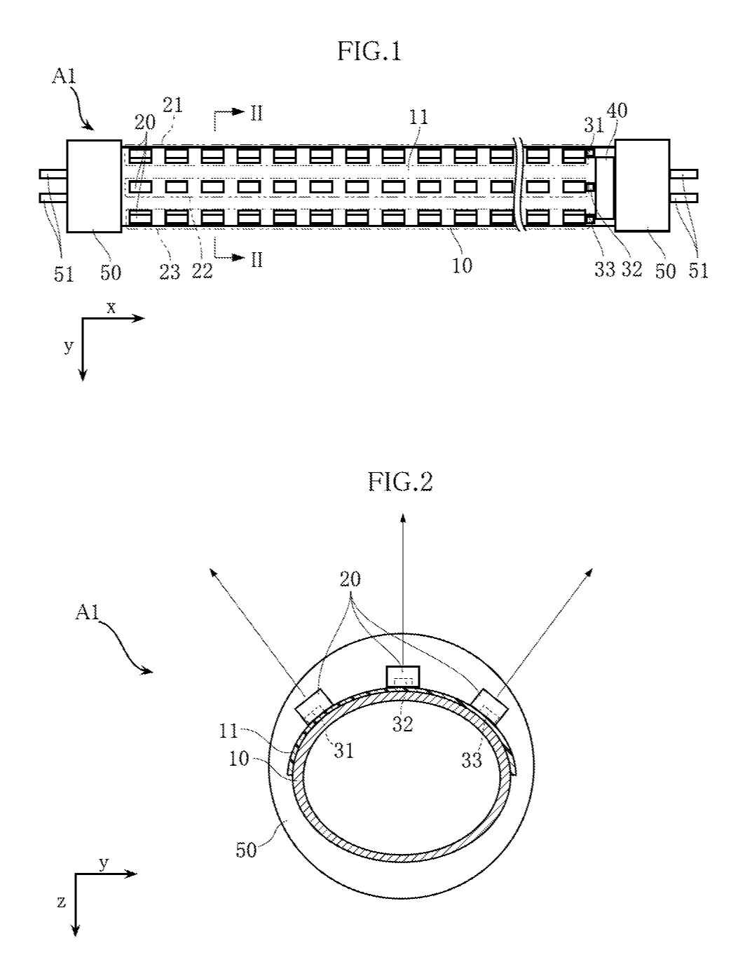

FIGS. 1 and 2 show an LED lamp according to a first embodiment of the present invention. The LED lamp A1 of this embodiment is in the form of a straight tube elongated in x direction, and includes a substrate 10, a plurality of LED modules 20, receivers 31, 32, 33, a controller 40, bases 50 and a case, not shown, in the form of a straight tube. For instance, the LED lamp A1 is used as attached to a general-purpose fluorescent lighting fixture as a substitute for a straight-tube fluorescent lamp. The LED lamp A1 is configured to be fixed to e.g. a ceiling and operable by a remote control.

The substrate 10 is made of e.g. aluminum and has a cylindrical shape elongated in direction x. The surface of the substrate 10 on one side in direction z is covered with an insulating layer 11. The substrate 10 has an elliptical cross section having a major axis extending in direction y. A wiring pattern, not shown, is formed on the surface of the insulating layer 11. It is to be noted that the upper side in FIG. 2 is the floor side, whereas the lower side in FIG. 2 is the ceiling side.

Each of the LED modules 20 includes an LED and a resin package covering the LED. The LED module is electrically connected to the controller 40 via the wiring pattern, not shown, on the insulating layer 11. The LED module 20 assumes either a light-emission state (ON) or anon-light-emission state (OFF) under the control by the controller 40. The LED incorporated in the LED module 20 has e.g. a lamination structure made up of an n-type semiconductor layer, a p-type semiconductor layer and an active layer sandwiched between these layers. The LED chip can emit blue light when made of a GaN-based semiconductor. The resin package is made of e.g. a silicone resin that allows the light from the LED to pass therethrough. The resin package contains a fluorescent substance mixed therein that emits e.g. yellow light when excited by blue light. This arrangement allows the LED module 20 to emit while light. Alternatively, use may be made of a mixture of a fluorescent substance that emits red light when exited by blue light and a fluorescent substance that emits green light.

The LED modules 20 are arranged in rows extending in direction x, i.e., a first row 21, a second row 22 and a third row 23. The first row 21, the second row 22 and the third row 23 are parallel to each other and arranged side by side in direction y.

The first row 21 is provided close to one end of the substrate 10 indirection y. The second row 22 is provided at the center of the substrate 10 in direction y. The third row 23 is provided close to the other end of the substrate 10 in direction y. As illustrated in FIG. 2, the LED modules 20 included in the first row 21, those included in the second row 22 and those included in the third row 23 are different from each other in illumination range.

Each of the receivers 31, 32 and 33 comprises e.g. an infrared sensor module, and receives a signal from a remote control and transmits the received signal to the controller 40 via the wiring pattern, not shown, on the insulating layer 11. The receiver 31 is arranged at the same position as the first row 21 in direction y. The receiver 32 is arranged at the same position as the second row 22 in direction y. The receiver 33 is arranged at the same position as the third row 23 indirection y. The light receiving range of the receivers 31, 32 and 33 are narrower than that of infrared sensor modules mounted on general electronic apparatuses.

The controller 40 comprises e.g. an IC module, and is mounted on the insulating film 11 to receive the signal transmitted from the receivers 31, 32, 33 and control the LED modules 20 in accordance with the signal. The controller 40 performs control to switch on or off the LED modules 20 included in the first row 21 upon receiving a signal from the receiver 31, switch on or off the LED modules 20 included in the second row 22 upon receiving a signal from the receiver 32, and switch on or off the LED modules 20 included in the third row 23 upon receiving a signal from the receiver 33.

The bases 50 are cylindrical members made of e.g. aluminum and holding terminal pins 51, and provided at ends of the substrate 10 in direction x. The terminal pins 51 are electrically connected to the wiring pattern, not shown, on the insulating film 11. Fitting the terminal pins 50 of the two bases 50 into the inlet ports of sockets of a general-purpose fluorescent lighting fixture allows electric power to be supplied to the LED modules 20 and the controller 40.

The operation and advantages of the LED lamp A1 are described below.

Explanation is given below as to the case where the LED lamp A1 is attached to the ceiling of a room and the LED lamp is not on in the initial state. For instance, when the remote control is operated from one side of the room in direction y, the signal emitted from the remote control is received only by the receiver 31. At this time, the control means 40 performs control to turn on only the LED modules 20 included in the first row 21. Thus, the LED lamp A1 illuminates only the one side of the room in direction y with light.

When the remote control is operated from directly below the LED lamp A1 for example, the signal emitted from the remote control is received only by the receiver 32. At this time, the control means 40 performs control to turn on only the LED modules 20 included in the second row 22. Thus, the LED lamp A1 illuminates only the area directly below the LED lamp A1 with light, without unnecessarily directing light toward the sides of the room.

When the remote control is operated from the other side of the room in direction y for example, the signal emitted from the remote control is received only by the receiver 33. At this time, the control means 40 performs control to turn on only the LED modules 20 included in the third row 23. Thus, the LED lamp A1 illuminates only this side of the room in direction y with light.

As described above, the LED lamp A1 illuminates only a particular area in which the person operating the remote control is present and does not turn on the LED modules 20 oriented toward the areas which do not need to be illuminated with light. Thus, power consumption is suppressed.

The signal from the remote control may be received by both the receivers 31 and 32 when the remote control is operated from a position relatively close to the LED lamp A1 on one side of the room in direction y. In this case, both the LED modules included in the first row 21 and those included in the second row 22 are turned on. However, the LED lamp A1 can still suppress power consumption, because the LED modules 20 included in the third row 23 are not turned on. Similarly, the signal from the remote control may be received by both the receivers 32 and 33 when the remote control is operated from a position relatively close to the LED lamp A1 on the other side of the room in direction y. In this case again, the LED lamp A1 can still suppress power consumption, because the LED modules 20 included in the first row 21 are not turned on.

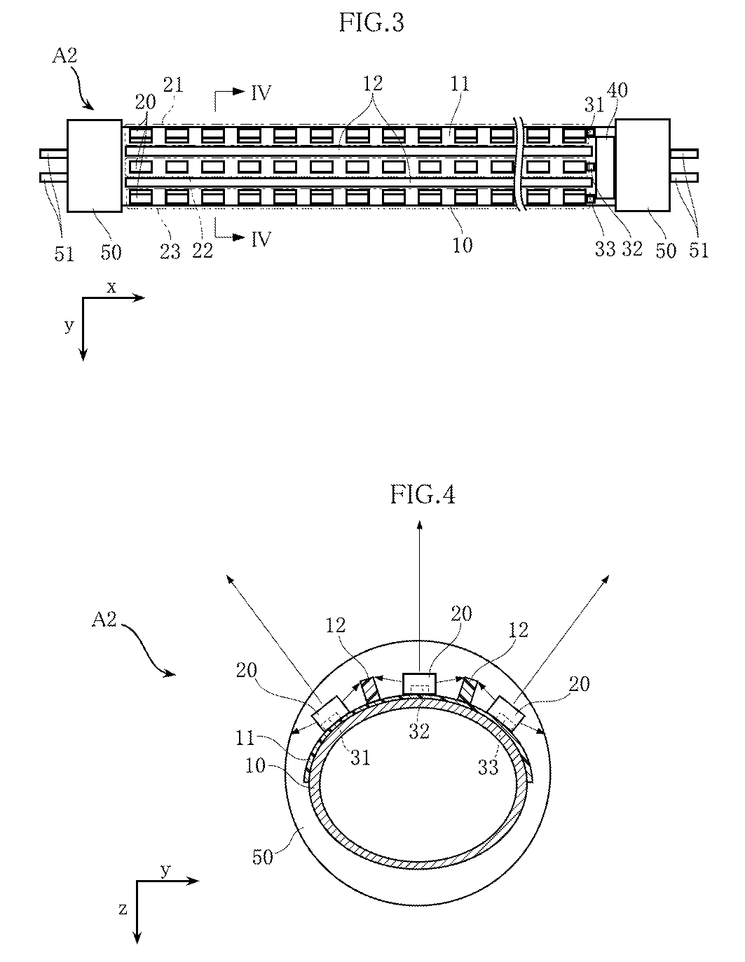

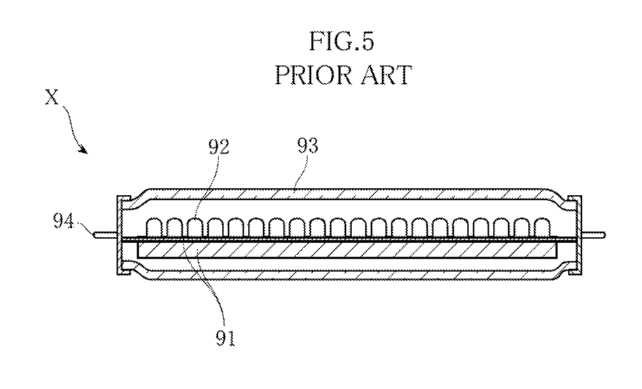

FIGS. 3 and 4 illustrate an LED lamp according to a second embodiment of the present invention. In these figures, the elements that are identical or similar to those of the foregoing embodiment are designated by the same reference signs as those used for the foregoing embodiment. The LED lamp A2 of this embodiment differs from that of the foregoing embodiment in that a plurality of light-shielding walls 12 are provided.

The light-shielding walls 12 are made of e.g. an opaque resin that can block light emitted from the LED modules 20 and provided on the substrate 10. The light-shielding walls 12 extend in direction x and have a length substantially reaching the ends of the substrate 11. In this embodiment, two light-shielding walls 12 are disposed between the first row 21 and the second row 22 and between the second row 22 and the third row 23. The light-shielding walls 12 have a height approximately equal to that of the LED modules 20. Preferably, in the height direction of the LED modules 20, the light-shielding walls 12 have a size and position such that the light-shielding walls overlap the LED modules 20.

According to this embodiment, when a selected one of the first row 21, the second row 22 and the third row 23 is turned on, light from the LED modules 20 included in that row is prevented from traveling to the sides. Thus, the areas illuminated by the first row 21, the second row 22 and the third row 23 are clearly differentiated.

The LED lamp according to the present invention is not limited to the foregoing embodiments. The specific structure of each part of the LED lamp according to the present invention may be varied in design in various ways. For instance, the LED modules 20 can be arranged in any number of rows as long as it is not less than two. Instead of using LED modules 20, a plurality of LEDs may be directly mounted on the substrate 10.

In the foregoing embodiments, the illumination direction changes depending on which of the three receivers 31, 32, 33 receives the signal. Unlike this, means to specify the illumination direction may be provided on the remote control side. In this case, a single receiver suffices, and the controller 40 performs control to turn on only the LED modules 20 included in the row specified by the remote control side.

Although the LED lamp A1 of a straight-tube shape is described in the foregoing embodiment, the present invention is applicable to circular LED lamps.

1. An LED lamp comprising:
a plurality of LEDs; and
a controller for switching the LEDs between a light-emission state and a non-light-emission state;
wherein the controller performs control to bring only part of the LEDs into the light-emission state.

2. The LED lamp according to claim 1, wherein: the LEDs are arranged in a plurality of rows extending parallel to each other; and
the controller performs switching of the LEDs between the light-emission state and the non-light-emission state individually with respect to each of the rows.

3. The LED lamp according to claim 2, including at least one receiver for receiving a signal from outside, the receiver being connected to the controller;
wherein the controller performs control to switch the LEDs included in at least one of the rows between the light-emission state and the non-light-emission state in accordance with a signal received by the receiver.

4. The LED lamp according to claim 3, wherein: a same number of receivers as a number of rows is provided; and
the controller makes the plurality of rows associated with different receivers, respectively, and when one of the receivers receives a signal from outside, the controller performs control to switch the LEDs included in the row associated with the receiver between the light-emission state and the non-light-emission state.

5. The LED lamp according to claim 2, further comprising at least one light-shielding wall extending parallel to the rows and arranged between adjacent ones of the rows.

6. The LED lamp according to claim 5, wherein at least part of the light-shielding wall overlaps the LEDs in a direction perpendicular to both the direction in which the rows extend and a direction in which the rows are arranged side by side.
